(19) United States
(12) Patent Application Publication
(10) Pub. No.: US 2017/0334097 A1
(43) Pub. Date: Nov. 23, 2017

(54) DEVICE AND METHOD FOR CONTROLLING THE TEMPERATURE OF A MOLD USING A LASER BEAM

(71) Applicant: Compagnie Plastic Omnium, Lyon (FR)

(72) Inventors: Olivier TORRES, Saint-genis Laval (FR); Stephane GUILLIER, Dagneux (FR)

(73) Assignee: Compagnie Plastic Omnium, Lyon (FR)

(21) Appl. No.: 15/524,072

(22) PCT Filed: Nov. 6, 2015
(86) PCT No.: PCT/FR2015/053015

§ 371 Date: Jun. 8, 2017

(30) Foreign Application Priority Data
Nov. 7, 2014 (FR) 1460823

(51) Int. Cl. B29C 35/08; B29C 33/06; B29C 70/48

(52) U.S. Cl. CPC B29C 35/0805; B29C 70/48; B29C 33/06; B29C 2035/0838

(57) ABSTRACT

Example embodiments relate to a device for control of a temperature of a mold for manufacturing a plastic part, the device including a heat exchange plate including at least one radiation head. A heat-conductive material of the heat exchange plate is in contact with a localized area of a wall of the mold. The at least one radiation head being configured to emit a beam of rays toward the heat exchange plate. Moreover, the invention relates to a method for controlling the temperature of a mold for manufacturing a plastic part.

### FIELD OF THE INVENTION

This invention relates to a device for controlling the temperature of a mould.

### BACKGROUND OF THE INVENTION

Generally, to produce a plastic or composite part in the automotive field, metal injection or compression moulds are used, the molding areas being alternately heated and cooled to adapt the material contained in the mould to the required shape.

Conventional devices for controlling the temperature of a mould are therefore generally composed of heating and/or cooling means using conduction of hot pressurized water, the heating means operating in particular by induction, electrical resistance, or by circulation of fluids (water, oil, etc.) or gas (pressurized steam).

Such devices have numerous disadvantages. Being devices with heating means employing circulation of fluids, to heat the areas in contact with the part, the heating means must cross other areas of the mould (walls in particular), resulting in a loss of heat and significant inertia in the heating and cooling cycles. Devices with heating means employing induction or electrical resistance avoid some of these disadvantages, but have others, such as very high energy consumption and the fact that they can only be used to produce parts of small dimensions and substantially flat shape.

Apart from the poor energy efficiency of such devices, they make the design and manufacture of the mould more complex. This is especially the case for devices with heating means employing circulation of fluids which require the installation of drilled circuits which follow the shapes of the molding surface.

There is therefore a need for a device for controlling the temperature of a mould that is energetically efficient and which simplifies the design and manufacture of the mould.

A proposal has also already been made, in EP 2 647 479, for a method for manufacturing a foamed plastic material part comprising the steps of injecting foamed material into a heated mould and cooling the mould. The mould is however heated homogeneously on all its walls in contact with the material of the part to be made, for example by laser.

This type of method therefore suffers from many of the disadvantages mentioned above.

### OBJECT AND SUMMARY OF THE INVENTION

The invention aims to remedy these disadvantages by providing a device for controlling the temperature of a mould for manufacturing a plastic part comprising means for heating the molding surface comprising at least one radiation head.

The invention stands out by the fact that the heating means comprise a heat exchange plate made of a heat-conductive material and arranged such as to be in contact with a localized area of a wall of the mould, the radiation head being adapted to control the temperature of the heat exchange plate by emitting a beam of rays that is directed toward the heat exchange plate.

Such a device, due to its localized temperature control, avoids the high inertia in the heating and cooling cycles and the heat losses caused by global heating, while being energetically efficient.

The use of a device according to the invention also avoids having to provide a complex network of pipes to cool the entire mould. Simplifying this network, or even not using such a network, reduces the investment costs, assembly and disassembly time, and also reduces the size of the blocks forming the mould.

Maintenance of the cooling system is also made less frequent due to a reduction in the size of the network and therefore of the potential leaks.

The use of radiation heads also proves to be particularly advantageous since they allow the temperature to be increased very rapidly, which can sometimes accelerate even further the molding cycles.

In addition, being particularly reliable, their use reduces the risks of failure and therefore reduces maintenance time and the associated costs.

In a preferred embodiment, the heating means comprise a heat insulating plate arranged between the radiation head and the heat exchange plate, said heat insulating plate being provided with an orifice allowing the passage of a beam of rays.

This is particularly useful for protecting the heating means when manufacturing parts using a compression or injection method.

In particular, this prevents the radiation head from being damaged due to a temperature increase of the plate of conductive material.

In a particular embodiment, which offers the advantage of being simple to implement, the radiation head is a laser source comprising an optical head connected to a supply source via an optical fiber.

In a preferred embodiment, the control device further comprises means for modulating the radiation power in order to vary the temperature of the heat exchange plate.

This allows better control of the temperature of the localized area of the wall and therefore of the material to be molded to form the part.

In particular, this allows the use of manufacturing methods in temperature stages such as molding methods by low pressure resin transfer molding.

According to a particular embodiment, the heating means are arranged in a metal body intended to be placed in a cavity formed in the wall of the mould.

This offers the advantage of making the device more modular, and in particular of being able to easily replace and/or move the heating means in the mould.

In a mode advantageous in terms of efficiency, the shape of the heat exchange plate is identical or similar to that of the localized area of the wall of the mould in order to be positioned at any point at a substantially constant distance from this localized area.

In a particular embodiment, the heat exchange plate is made of graphite or graphene.

Graphite is a material particularly suitable for making the heat exchange plate since it is both a good heat conductor and resistant to high temperatures.

In a particular embodiment, the heat insulating plate is made of a microporous material.

Note that a microporous material is one with a porous structure, in other words comprising closed cells whose dimensions are less than the mean free path of some molecules.

Such materials are particularly suitable for making the heat insulting plate since, by nature, they consist of cells filled with gas, and therefore benefit from very low thermal conductivity.

The invention also relates to a mould for manufacturing a plastic part comprising a device for controlling the temperature according to the invention.

The invention also relates to a method for controlling the temperature of a mould for manufacturing a plastic part by controlling the temperature of a heat exchange surface by emitting a beam of rays that is directed toward a heat exchange surface made of a heat-conductive material and arranged such as to be in contact with a localized area of the wall of the mould.

### BRIEF DESCRIPTION OF THE DRAWINGS

The invention will be better understood on reading the description of the accompanying figures, which are given solely by way of example and not limiting in any way, in which:

FIG. 1 is a diagrammatic representation of a cross-section of a mould for manufacturing a plastic part provided with a device for controlling the temperature according to the invention;

FIG. 2 is a diagrammatic representation of means for heating a device for controlling the temperature of FIG. 1.

### MORE DETAILED DESCRIPTION

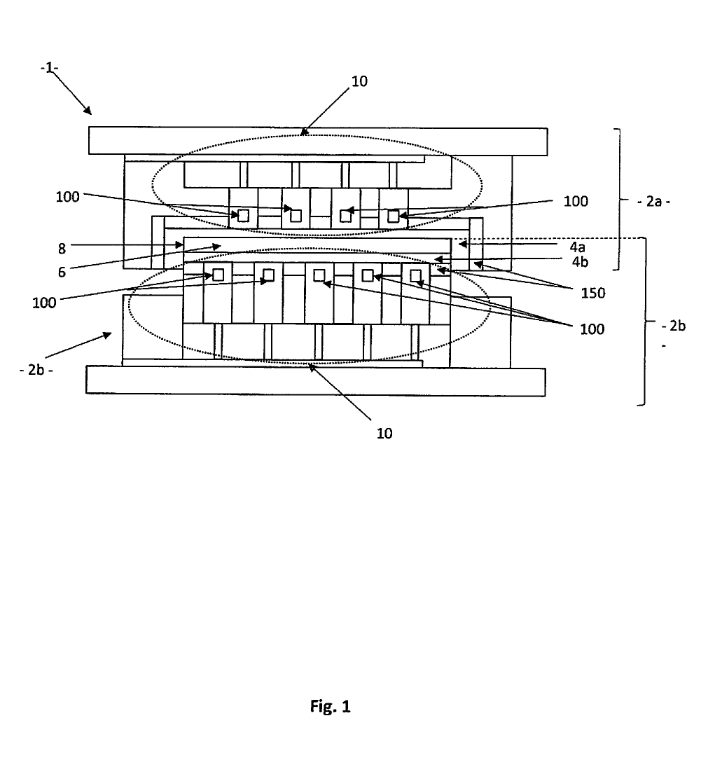

FIG. 1 shows a mould 1 according to one embodiment of the invention.

It comprises an upper block 2a and a lower block 2b respectively comprising an upper wall 4a and a lower wall 4b which together define a chamber 6. The material forming a part 8 is molded in this chamber 6.

The mould 1 comprises a device 10 for controlling the temperature, which comprises, in the embodiment as shown, a plurality of heating means in the form of boosters 100.

Preferably, a plurality of boosters 100 are arranged each side of the chamber 6, in other words boosters 100 are arranged both in the upper block 2a and in the lower block 2b.

In another embodiment, not shown, there may be boosters 100 only in the upper block 2a or only in the lower block 2b.

In the embodiment shown on FIG. 1, the boosters 100 are evenly distributed along the upper block 2a and the lower block 2b opposite the chamber 6. Obviously, their arrangement, as well as their number and size or shape, may vary depending on the required uses. Thus, the boosters 100 may be distributed in a staggered configuration (in the direction normal to the figure) with a precise pitch, or not.

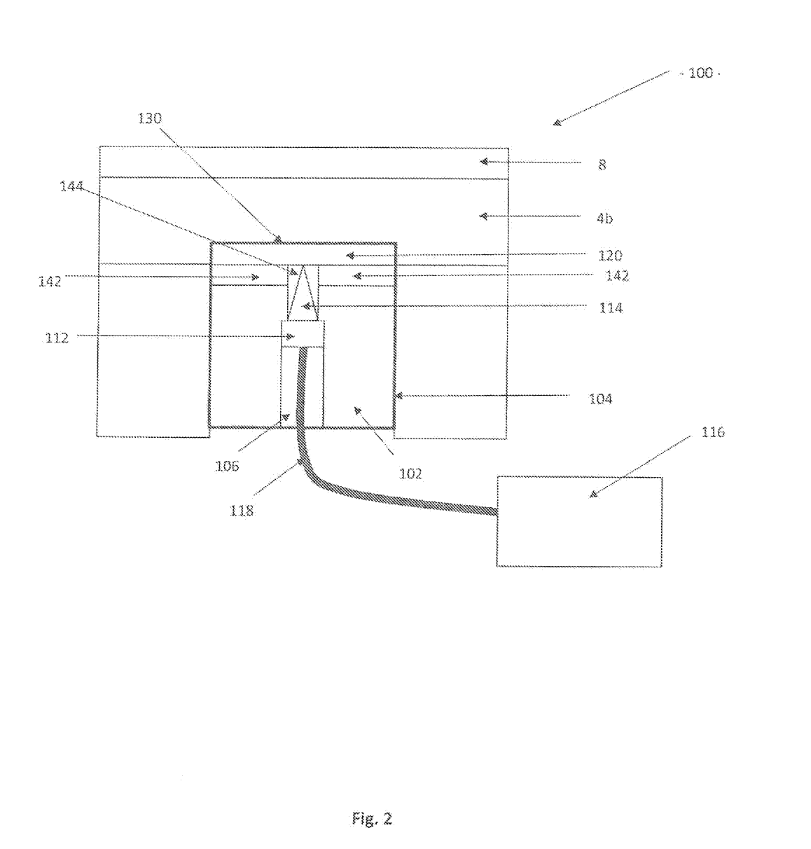

One of these boosters 100 is shown more precisely on FIG. 2.

Each booster 100 comprises a body 102, preferably made of a metallic material, which is arranged in a cavity 104 formed in the mould 1.

The body 102 houses, in a space 106, a radiation head 112, for example infrared or laser. In this case, it consists of a laser head 112 adapted to emit a laser beam 114 and a supply source 116 via an optical fiber 118.

Note that on FIG. 1, the supply sources of the laser heads are not shown and that the representation of the boosters has been simplified for reasons of clarity.

Moreover, in a variant not shown, the laser beam 114 may be transmitted and/or guided by mirrors rather than by an optical fiber. The body 102 also houses a heat exchange plate 120 made of a heat-conductive material (of high thermal conductivity) such as graphite, which is arranged in the cavity 104 such as to be in contact with a localized area 130 of the lower wall 4b of the chamber 6 of the mould.

The localized area 130 is itself in contact with a localized area of the part 8 to be molded.

Preferably, the entire surface of the heat exchange plate 120 is in contact with a localized area 130 of the associated lower wall 4b.

Even more particularly, the shape of the heat exchange plate 120 is advantageously identical or similar to that of the localized area 130 of the mould lower wall 4b in order to be positioned at any point at a substantially constant distance from this localized area.

The heat exchange plate 120 is placed on the path of the laser beam 114 so that the laser beam 114 can heat it by radiation.

Thus, the heat exchange plate 120 being in contact with the localized area 130 of the lower wall 4b of the mould 1, it transmits by conduction the heat produced by radiation to the localized area 130. However, it transmits no or very little heat to the rest of the mould 1, thereby avoiding global heating and the associated disadvantages.

The localized area 130 of the lower wall 4b being itself in contact with a localized area of the part 8 to be manufactured, it transmits in turn by conduction this heat to the localized area of the part 8. However, it does not transmit heat to the entire part 8, which increases the molding accuracy.

Similarly, the other boosters 100 heat the localized areas of the upper wall 4a and lower wall 4b in front of which they are located, and consequently the associated localized areas of the part 8.

Preferably, the control device 10 further comprises means for modulating the radiation power, for example by modulation (of the power/intensity, focal length, wavelength, “on/off” cycling, etc.) of the laser beam 114 in order to vary the temperature of the heat exchange plate 120. These means are not shown in detail and are for example integrated into the supply source 116.

As can be seen on FIG. 2, in the preferred embodiment shown here, the body 102 also houses a heat insulating plate 142 arranged between the heat exchange plate 120 and the radiation head 112.

The heat insulating plate 142 protects the radiation head 112 from the heat generated by emission of the beam 114 of rays on the heat exchange plate 120. In this case, the aim is to protect the laser head 112.

The heat insulating plate 142 is therefore provided with an orifice 144 allowing the passage of the laser beam 114.

The heat insulating plate 142 is preferably made of a microporous material which has the advantage of benefiting from very low thermal conductivity.

As can be seen on FIG. 1, in the preferred embodiment shown here, the mould 1 comprises heat insulating means 150 arranged around the boosters 100. These heat insulating means are arranged to form a closed space around the chamber 6, thus forming an insulating jacket, like a sarcophagus, around the boosters 100. These means thus confine the heat in the chamber 6. This jacket is sandwiched between the two blocks (2a, 2b) of the mould 1 and must therefore withstand the pressure inside the mould 1.

Note that other configurations of the heat insulating means 150 may be considered depending on the shape and arrangement of upper block 2a and lower block 2b.

Generally, the invention is not limited to the embodiments described and other embodiments will be clearly apparent to those skilled in the art.

Thus, the radiation head may be placed directly inside the mould: in this case, emission of the beam of rays is direct.

1. A device for controlling a temperature of a mold for manufacturing a plastic part comprising:
heating means for heating the molding surface and including at least one radiation head,
wherein the heating means include a heat exchange plate made of a heat-conductive material and arranged such as to be in contact with a localized area of the wall of the mold,
the at least one radiation head being configured to control the temperature of the heat exchange plate by emitting a beam of rays toward the heat exchange plate.

2. The device according to claim 1, wherein the heating means comprise a heat insulating plate between the radiation head and the heat exchange plate, said heat insulating plate including an orifice allowing passage of the beam of rays.

3. The device according to claim 1, wherein the radiation head is a laser source comprising an optical head connected to a supply source via an optical fiber.

4. The device according to claim 1, further comprising means for modulating the radiation power in order to vary the temperature of the heat exchange plate.

5. The device according to claim 1, wherein the heating means are in a metal body configured to be placed in a cavity formed in the wall of the mold.

6. The device according to claim 1, wherein a shape of the heat exchange plate is identical to a shape of the localized area of the wall of the mold and is at a substantially constant distance from the localized area.

7. The device according to claim 1, wherein the heat exchange plate comprises graphite or graphene.

8. The device according to claim 1, wherein the heat insulating plate comprises a microporous material.

9. A Mold for manufacturing a plastic part comprising the device according to claim 1.

10. A method for controlling the temperature of a mold for manufacturing a plastic part, the method comprising:
emitting a beam of rays toward a heat exchange plate made of a heat-conductive material and arranged to be in contact with a localized area of the wall of the mold to control the temperature of the heat exchange plate.

11. A device for control of a temperature of a mold for manufacturing a plastic part, the device comprising:
a heat exchange plate including at least one radiation head,
a heat-conductive material of the heat exchange plate being in contact with a localized area of a wall of the mold,
the at least one radiation head being configured to emit a beam of rays toward the heat exchange plate.
